(19) United States
(12) Patent Application Publication
(10) Pub. No.: US 2025/0233868 A1
(43) Pub. Date: Jul. 17, 2025

(54) METHOD AND SYSTEM OF TRAFFIC SAMPLING IN VEHICULAR NETWORKS

(71) Applicant: KONGJU NATIONAL UNIVERSITY INDUSTRY-UNIVERSITY COOPERATION FOUNDATION, Gongju-si (KR)

(72) Inventor: Yonggang KIM, Cheonan-si (KR)

(21) Appl. No.: 18/753,523

(22) Filed: Jun. 25, 2024

(30) Foreign Application Priority Data
Jan. 16, 2024 (KR) 10-2024-0007033

(51) Int. Cl. H04L 9/40; H04L 67/12; H04W 4/46

(52) U.S. Cl. CPC H04L 63/1408; H04L 67/12; H04W 4/46

(57) ABSTRACT

A method for traffic sampling in vehicular networks is disclosed. The method for traffic sampling in vehicular networks according to the present invention includes the steps of receiving inter-vehicle flow information; and determining a sampling amount to extract some of data included in the flow information.

### CROSS-REFERENCE TO RELATED APPLICATION

This application claims priority to and the benefit of Korean Patent Application No. 10-2024-0007033, filed on Jan. 16, 2024, the disclosure of which is incorporated herein by reference in its entirety.

### TECHNICAL FIELD

The present invention relates to a method and system for traffic sampling in vehicular networks.

### BACKGROUND ART

As the usage of various network-based information, such as autonomous driving, infotainment systems, remote diagnosis and wireless vehicle management, continues to grow, the demand for vehicular networking is expected to increase significantly.

Many sensors or functions can be implemented on vehicles to support better vehicle services, including object detection, collision avoidance and wireless connectivity. In addition, various vehicular services utilizing machine learning technology have begun to be applied to improve service performance in complex vehicular environments. Although vehicular services or machine learning technologies supporting vehicular services could be performed by individual vehicles, cooperative management through information sharing can potentially improve service performance or efficiency.

With the help of vehicle-to-vehicle (V2V) or vehicle-to-infrastructure (V2I) systems, each vehicle may transmit its local data to other nodes, such as other nearby vehicles, dedicated roadside units or base stations (BSs).

As the significance of cooperation among vehicles and base stations increases in the context of intelligent vehicular functions and management, the inspection of incoming packets at each vehicle becomes a fundamental requirement to ensure the security of vehicular services. At the same time, responding to malicious data has become an important task in vehicular networks.

In order to prevent vehicular service malfunctions or performance degradation, an intrusion detection system (IDS) that performs deep packet inspection and examines the detailed payload and headers to analyze the content and identify security threats could be implemented on vehicles However, the proliferation of connected cars and the increase of vehicle-to-everything (V2X) communications introduce heightened risks to in-vehicle network security, because inspecting all vehicular packets at the in-vehicle IDS becomes challenging.

### DISCLOSURE

### Technical Problem

The technical problem to be solved by the present invention is to provide a method and system for traffic sampling in vehicular networks that maximize the detection probability of malicious packets and prevent network performance degradation by determining the amount of traffic sampling in consideration of the trade-off relationship in the vehicular network.

### Technical Solution

In order to solve the above technical problem, the method for traffic sampling in vehicular networks according to an exemplary embodiment of the present invention may include the steps of receiving inter-vehicle flow information; and determining a sampling amount to extract some of data included in the flow information, wherein the step of determining a sampling amount includes the steps of setting a trade-off parameter which sets a weight between a detection success probability and an outage probability of delay constraint, by considering the trade-off relationship between the detection success probability of malicious packets included in the data and the outage probability of delay constraint on networks involved in inter-vehicle flows; generating a sampling set by generating sampling rates at least two times for each relay node involved in the flow; and determining a sampling set by selecting any one of sets of the sampling rates for each relay node generated two times or more.

In an exemplary embodiment of the present invention, the step of determining a sampling set may select a set that maximizes a value calculated by Mathematical Formula below among the sets of sampling rates:

$$λ {\overline{P}}^{succ} - ( 1 - λ ) {\overline{P}}^{out , upper} \qquad [ Mathematical Formula ]$$

(wherein λ represents the trade-off parameter, P̅^{succ} represents the detection success probability for the sampling rate set, and P̅^{out,upper} or represents the upper limit of the outage probability of delay constraint for the sampling rate set).

In an exemplary embodiment of the present invention, the method may further include the step of sampling traffic according to the determined sampling rate and transmitting to a packet inspection server, wherein the step of generating a sampling set generates the sampling set on a condition that the total amount of data transmitted to the packet inspection server according to the traffic amount of each relay node and the determined sampling rate is lower than or equal to the processing capacity of the packet inspection server.

In an exemplary embodiment of the present invention, the sampling rate for each relay node involved in the flow may be generated as a random value within a set range.

In an exemplary embodiment of the present invention, the step of determining a sampling amount may further include the steps of calculating a required number of relay nodes for all flows; sorting flows in ascending order corresponding to the number of relay nodes, and sorting the relay nodes in flow order of each flow; generating sampling rates for all flows in the sorted relay node order and in the sorted flow order, storing the generated sampling rates as a sampling rate set; and generating two or more sampling rate sets by repeating the steps of generating sampling rates and storing the sampling rate set as many times as a preset number of repetitions.

In order to solve the above technical problem, the system for traffic sampling in vehicular networks according to an exemplary embodiment may include at least one relay node for routing packets transmitted in vehicle-to-vehicle communication; and a processor for controlling individual routing of the relay node, wherein the processor receives inter-vehicle flow information and determines a sampling amount to extract some of data included in the flow information, and wherein determining a sampling amount is performed by setting a trade-off parameter which sets a weight between a detection success probability and an outage probability of delay constraint, by considering the trade-off relationship between the detection success probability of malicious packets included in the data and the outage probability of delay constraint on networks involved in inter-vehicle flows, by generating sampling rates at least two times for each relay node involved in the flow, and by selecting any one of sets of the sampling rates for each relay node generated two times or more.

### Advantageous Effects

The present invention has the effect of preventing network performance degradation while maximizing the detection probability of malicious packets by determining the amount of traffic sampling in consideration of the trade-off relationship in vehicular networks.

### DESCRIPTION OF DRAWINGS

FIG. 1 is a block diagram showing the system for traffic sampling in vehicular networks according to an exemplary embodiment of the present invention.

FIG. 2 is a conceptual diagram showing the system for traffic sampling in vehicular networks according to an exemplary embodiment of the present invention.

FIG. 3 shows the traffic sampling method in vehicular networks according to an exemplary embodiment of the present invention.

FIG. 4 shows in detail some configurations of the traffic sampling method in vehicular networks according to an exemplary embodiment of the present invention.

FIG. 5 is a visual representation of the entire flow to simply illustrate the traffic sampling method in vehicular networks according to an exemplary embodiment of the present invention.

FIG. 6 shows the upper limit of the delay outage probability as a function of the relay node performing sampling.

FIG. 7 is a graph showing the detection success probability when the number of relay nodes is 6.

FIG. 8 is a graph showing the delay outage probability when the number of relay nodes is 6.

FIG. 9 is a graph showing the detection success probability and the delay outage probability when the number of relay nodes is 6.

FIG. 10 is a graph showing the detection success probability when the number of relay nodes is 12.

FIG. 11 is a graph showing the delay outage probability when the number of relay nodes is 12.

FIG. 12 is a graph showing the detection success probability and the delay outage probability when the number of relay nodes is 12.

### MODES OF THE INVENTION

Since the present invention can be modified in various ways and have various exemplary embodiments, specific exemplary embodiments will be illustrated in the drawings and described in detail. However, this is not intended to limit the present invention to specific exemplary embodiments, and it should be understood to include all transformations, equivalents and substitutes included in the spirit and technical scope of the present invention.

In terms of describing the present invention, if it is determined that the detailed description of related known technologies may obscure the gist of the present invention, the detailed description thereof will be omitted.

Hereinafter, the exemplary embodiments of the present invention will be described in detail with reference to the accompanying drawings.

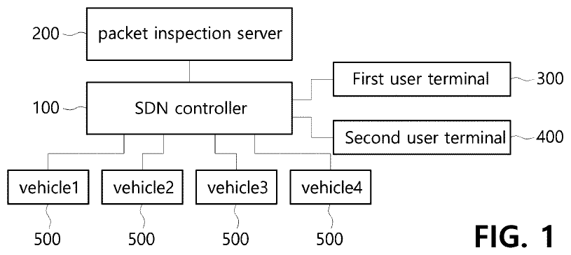

FIG. 1 is a block diagram showing the system for traffic sampling 100 in vehicular networks according to an exemplary embodiment of the present invention.

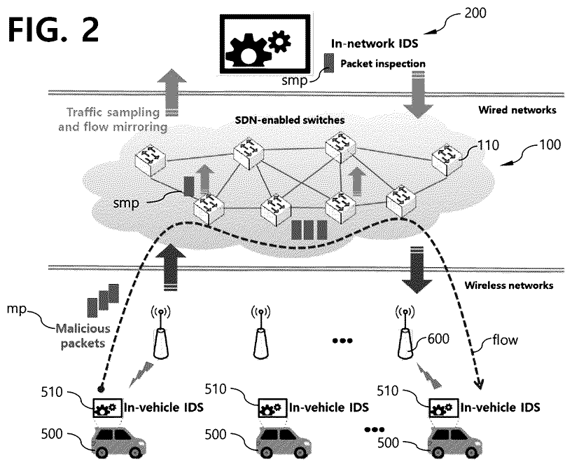

FIG. 2 is a conceptual diagram showing the system for traffic sampling 100 in vehicular networks according to an exemplary embodiment of the present invention.

Referring to FIGS. 1 and 2, the system for traffic sampling 100 (hereinafter, also referred to as a “traffic sampling system 100”) in the network of a vehicle includes a relay node 110.

Although not illustrated in the drawing, the traffic sampling system 100 may include a processor, a communication unit and a storage unit.

The processor may be connected to the relay node 110, the communication unit and the storage unit to control the same.

The processor may perform operations on traffic sampling.

The communication unit may transmit control commands to each relay node 110.

The relay node 110 may be connected to a wired network.

The relay node 110 and the base station 600 may be connected through a wireless network. These may be called heterogeneous networks.

The communication unit may transmit and receive information with a packet inspection server 200, a first user terminal 300 and a second user terminal 400.

The storage unit may store information that is necessary for calculations, such as flows, parameters and variables related to traffic sampling.

The storage unit may provide the stored information to the processor.

The traffic sampling system 100 configured in this way may be an SDN controller (Software Defined Network Controller).

The packet inspection server 200 receives sampled packets from the traffic sampling system 100 and inspects the packets.

Packet inspection is performed to check whether the packet is a malicious packet (mp).

In FIG. 2, in the flow where information is transmitted from any one vehicle 500 to another vehicle 500, a sampling packet (smp) in which some of the malicious packets (mp) are sampled may be transmitted to the packet inspection server 200. In a network, this process can be referred to as traffic sampling and flow mirroring.

Sampled packets may not always contain malicious packets. However, as the probability that sampled packets include malicious packets is higher, the detection success probability of detecting malicious packets will become higher. If even one of the relay nodes 110 associated with the flow includes a malicious packet and sampling is performed, it can be said that a malicious packet sample has been provided so as to detect the malicious packet.

Although not illustrated in the drawings, the first user terminal 300 may include a processor, a communication unit, a storage unit and an input unit.

The processor may be connected to the communication unit, storage unit, and input unit to control the same.

The communication unit may transmit and receive information with the traffic sampling system 100.

The storage unit may store necessary information to provide convenience in information processing. The storage unit may store applications that can be installed on the first user terminal 300.

The input unit is an input interface for controlling the first user terminal 300, and it may be configured as a keyboard or a touch screen.

The terminal configured in this way may be, for example, any one of a smartphone, tablet PC and laptop. Even if it is not one of these, it is not limited to the above exemplary embodiment as long as it can perform the above functions.

A first user who owns and uses a first user terminal 300 may be an administrator of the network service of a vehicle 500. The administrator may set parameters and variables to be utilized by a traffic sampling system 100 and receive reports on information about malicious packets.

Although not illustrated in the drawings, a second user terminal 400 may include a processor, a communication unit, a storage unit and an input unit.

The processor may be connected to the communication unit, storage unit and input unit to control the same.

The communication unit may transmit and receive information with a traffic sampling system 100.

The storage unit may store necessary information to provide convenience in information processing. The storage unit may store applications that can be installed on the second user terminal 400.

The input unit is an input interface for controlling the second user terminal 400, and it may be configured as a keyboard or a touch screen.

The terminal configured in this way may be, for example, any one of a smartphone, a tablet PC and a laptop. Even if it is not one of these, it is not limited to the above exemplary embodiment as long as it can perform the above functions.

A second user who owns and uses the second user terminal 400 may be a driver of the vehicle 500. The driver of the vehicle 500 may receive and confirm information about whether a malicious packet has been detected through the second user terminal 400 and take necessary actions.

Vehicle 500 may transmit and receive necessary information in packet units with other vehicles 500 through a network.

For example, the packet transmitted from the vehicle 500 may be transmitted to the traffic sampling system 100 through the base station 600, and the traffic sampling system 100 may transmit the received packet to another base station 600 such that it may reach another vehicle 500.

Hereinafter, a traffic sampling method in the network of a vehicle will be described by using the traffic sampling system 100 as the main agent. Unless otherwise specified, the traffic sampling method in the network of a vehicle nay be understood as being performed by the operations of the traffic sampling system 100 and components thereof.

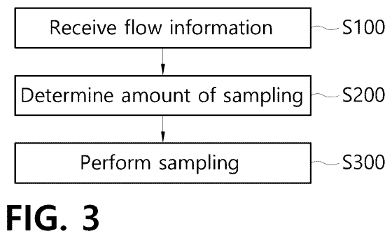

FIG. 3 shows the traffic sampling method in vehicular networks according to an exemplary embodiment of the present invention.

Referring to FIG. 3, in step S100, the traffic sampling system 100 receives flow information at a certain time point t.

Flow information may include information regarding information transmission requests between different vehicles 500.

In step S200, the traffic sampling system 100 determines the amount of sampling to be transmitted to the packet inspection server 200.

In step S300, the traffic sampling system 100 performs sampling to correspond to the determined sampling rate. The sampled packet may be transmitted to the packet inspection server 200.

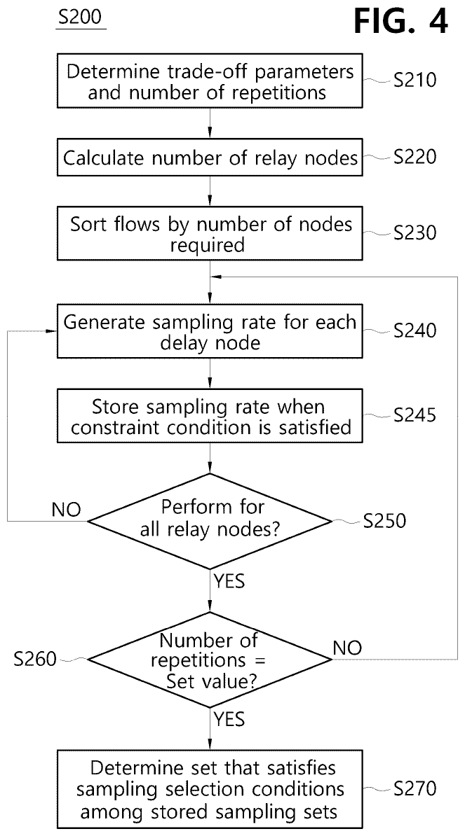

FIG. 4 shows step S200 in detail.

Before explaining step S200, the theoretical model applied to the present invention will be explained.

Flow may refer to the flow or path of packets transmitted from one vehicle 500 to another vehicle 500. Herein, the route may be about which relay nodes 110 it passes through. From a flow perspective, any one vehicle 500 is also called a source node, and it may be represented as vᵢ. From a flow perspective, the other vehicle 500 is also called a destination node, and it may be represented as vⱼ. The flow from vᵢ to vⱼ at any time t is defined as fᵥ_{_{i,}}ᵥ_{ⱼ}^{t}, and the set of total flows is defined as F_{V}^{t}={fᵥ_{_{i,}}ᵥ_{ⱼ}^{t}|vᵢ,vⱼ∈V}.

Herein, vᵢ may be the same as vⱼ. In this case, vᵢ may be performing task offloading. This may be to ease the workload of a vehicular packet inspection unit 510 in the vehicle 500.

R(fᵥ_{_{i,}}ᵥ_{ⱼ}^{t}) represents a set of relay nodes 110 involved in flow fᵥ_{_{i,}}ᵥ_{ⱼ}^{t}. The relay node 110 rₖ is an element of R(fᵥ_{_{i,}}ᵥ_{ⱼ}^{t}).

I_{nIDS} represents the processing capacity of a packet inspection server 200.

D(fᵥ_{_{i,}}ᵥ_{ⱼ}^{t}) represents the traffic amount (the amount of data) of flow fᵥ_{_{i,}}ᵥ_{ⱼ}^{t}.

The amount of data D(fᵥ_{_{i,}}ᵥ_{ⱼ}^{t}) may include a part caused by malicious data.

represents the malicious data ratio of

$${f}_{{v}_{i ,} {v}_{j}^{t}} \cdot {m}_{{f}_{{v}_{i ,} {v}_{j}^{t}}}$$

has a value in the range of

$$0 \leq {m}_{{f}_{{v}_{i ,} {v}_{j}^{t}}} \leq 1.$$

Meanwhile, mirroring and forwarding the sampling packet to the packet inspection server 200 may occur in both of the relay node 110 and the base station 600.

is expressed as the sampling rate at relay node 110 rₖ for flow

$${f}_{{v}_{i ,} {v}_{j}^{t}} \cdot {δ}_{{f}_{{v}_{i ,} {v}_{j}^{t} , {r}_{k}}}$$

has a value in the range of

$$0 \leq {δ}_{{f}_{{v}_{i ,} {v}_{j}^{t} , {r}_{k}}} \leq 1.$$

The sampling set of flows and the sampling set of total traffic of all flows at time t may each be expressed as [Mathematical Formula 1] below.

$$[ Mathematical Formula 1 ]$$

$${Δ}_{{f}_{{v}_{i} , {v}_{j}^{t}}} \{ {δ}_{{f}_{{v}_{i} , {v}_{j}^{t}} , {r}_{k}} \vert {r}_{k} ∈ R ( {f}_{{v}_{i} , {v}_{j}^{t}} \}$$

$${Δ}_{{F}_{V}^{t}} = \{ {Δ}_{{f}_{{v}_{i} , {v}_{j}^{t}}} \vert {f}_{{v}_{i} , {v}_{j}} ∈ {F}_{V}^{t} \}$$

The set of relay nodes 110 that perform actual sampling may be expressed as [Mathematical Formula 2]. In this case, the fact that the sampling rate is not 0 is a characteristic that distinguishes the same from the relay node 110 set described above.

$$[ Mathematical Formula 2 ]$$

$$\hat{R} ( {f}_{{v}_{i} , {v}_{j}^{t}} ) = \{ {r}_{k} \vert {r}_{k} ∈ R ( {f}_{{v}_{i} , {v}_{j}^{t}} ) , 0 〈 {δ}_{{f}_{{v}_{i} , {v}_{j}^{t}} , {r}_{k}} \leq 1 \}$$

The probability of failing to sample a malicious packet for the sampling relay node 110 rₖ may be expressed as [Mathematical Formula 3].

$$[ Mathematical Formula 3 ]$$

$$\begin{matrix}{p}^{fail} ( {r}_{k} , {f}_{{v}_{i} , {v}_{j}^{t}} , {Δ}_{{f}_{{v}_{i} , {v}_{j}^{t}}} ) = \{ \begin{matrix}0 , if D ( {f}_{{v}_{i} , {v}_{j}^{t}} ) ( 1 − {m}_{{f}_{{v}_{i} , {v}_{j}^{t}}} ) 〈 D ( {f}_{{v}_{i} , {v}_{j}^{t}} ) {δ}_{{f}_{{v}_{i} , {v}_{j}^{t}} , {r}_{k}} \\ \frac{C ( D ( {f}_{{v}_{i} , {v}_{j}^{t}} ) ( 1 − {m}_{{f}_{{v}_{i} , {v}_{j}^{t}}} ) , D ( {f}_{{v}_{i} , {v}_{j}^{t}} ) {δ}_{{f}_{{v}_{i} , {v}_{j}^{t}} {r}_{k}} )}{C ( D ( {f}_{{v}_{i} , {v}_{j}^{t}} ) , D ( {f}_{{v}_{i} , {v}_{j}^{t}} ) {m}_{{f}_{{v}_{i} , {v}_{j}^{t}}} )} , o / w\end{matrix} \\ = \{ \begin{matrix}0 , if D ( {f}_{{v}_{i} , {v}_{j}^{t}} ) ( 1 − {m}_{{f}_{{v}_{i} , {v}_{j}^{t}}} ) 〈 D ( {f}_{{v}_{i} , {v}_{j}^{t}} ) {δ}_{{f}_{{v}_{i} , {v}_{j}^{t}} , {r}_{k}} \\ \frac{\begin{matrix}Γ ( D ( {f}_{{v}_{i} , {v}_{j}^{t}} ) ( 1 − {m}_{{f}_{{v}_{i} , {v}_{j}^{t}}} + \\ 1 ) ) Γ ( D ( {f}_{{v}_{i} , {v}_{j}^{t}} ) ( 1 − {δ}_{{f}_{{v}_{i} , {v}_{j}^{t}} , {r}_{k}} ) + 1 )\end{matrix}}{Γ ( D ( {f}_{{v}_{i} , {v}_{j}^{t}} ) + 1 ) Γ ( D ( {f}_{{v}_{i} , {v}_{j}^{t}} ) ( {m}_{{f}_{{v}_{i} , {v}_{j}^{t}}} − {δ}_{{f}_{{v}_{i} , {v}_{j}^{t}} , {r}_{k}} ) + 1 )} , o / w\end{matrix}\end{matrix}$$

Herein, C(⋅,⋅) represents a combination function, and Γ(⋅) represents a gamma function, respectively. They have a relationship Γ(ν+1)=ν!.

The probability that a malicious packet is included in the sampling data (the detection success probability) is a value obtained by subtracting the failure probability that all relay nodes 110 involved in sampling from 1, and thus, it may be expressed as [Mathematical Formula 4].

$$[ Mathematical Formula 4 ]$$

$${P}^{succ} = ( \hat{R} ( {f}_{{v}_{i} , {v}_{j}^{t}} ) , {f}_{{v}_{i} , {v}_{j}^{t}} , {Δ}_{{f}_{{v}_{i} , {v}_{j}^{t}}} ) = 1 - {\prod }_{{r}_{k} ∈ \hat{R} ( {f}_{{v}_{i} , {v}_{j}^{t}} )} {P}^{fail} ( {r}_{k} , {f}_{{v}_{i} , {v}_{j}^{t}} , {Δ}_{{f}_{{v}_{i} , {v}_{j}^{t}}} )$$

τᵥ_{_{i,}}ᵣ_{_{k,}}ᵥ_{ⱼ}, represents the total delay when the relay node 110 rₖ performs sampling and performs flow mirroring to the packet inspection server 200 for the flow from vᵢ to vⱼ. Herein, rₖ∈\hat{R}(fᵥ_{_{i,}}ᵥ_{ⱼ}^{t}).

τᵥ_{_{i,}}ᵣ_{_{k,}}ᵥ_{ⱼ} may include processing delay, propagation delay and packet inspection delay in the packet inspection server 200.

Since all relay nodes 110 rₖ∈\hat{R}(fᵥ_{_{i,}}ᵥ_{ⱼ}^{t}) perform traffic sampling and flow mirroring, there may be a plurality of paths that must satisfy delay constraints.

Let the delay constraint be τₜₕ. The outage probability of delay constraint may be expressed as [Mathematical Formula 5]. The outage probability of delay constraint may mean the probability that at least one of each τᵥ_{_{i,}}ᵣ_{_{k,}}ᵥ_{ⱼ}^{t} exceeds τₜₕ. When it is expressed in another way, it may be expressed as a value obtained by subtracting the probability that τᵥ_{_{i,}}ᵣ_{_{k,}}ᵥ_{ⱼ}^{t} is less than or equal to τₜₕ for all rₖ (probability that a delay constraint outage will not occur) from I

$$[ Mathematical Formula 5 ]$$

$${P}^{o u t} = ( \hat{R} ( {f}_{{v}_{i} , {v}_{j}^{t}} ) , {f}_{{v}_{i} , {v}_{j}^{t}} , {Δ}_{{f}_{{v}_{i} , {v}_{j}^{t}}} ) = 1 - {\prod }_{{r}_{k} ∈ \hat{R} ( {f}_{{v}_{i} , {v}_{j}^{t}} )} P [ {τ}_{{v}_{i ,} {r}_{k ,} {v}_{j}} \leq {τ}_{th} ]$$

In the present invention, the outage probability of delay constraint is intended to be less than or equal to a threshold value oₒᵤₜ. That is, the object is

$$1 - {\prod }_{{r}_{k} ∈ \hat{R} ( {f}_{{v}_{i} , {v}_{j}^{t}} )} P [ {τ}_{{v}_{i ,} {r}_{k ,} {v}_{j}} \leq {τ}_{th} ] \leq {o}_{out} .$$

By taking logarithmic functions on both sides, the above inequality may be summarized as [Mathematical Formula 6].

The threshold value oₒᵤₜ may be a probability set by the traffic sampling system 100.

$$[ Mathematical Formula 6 ]$$

$${\sum }_{{R}_{k} = \hat{R} ( {f}_{{v}_{i} , {v}_{j}^{t}} )} ln P [ {τ}_{{v}_{i ,} {r}_{k ,} {v}_{j}} \leq {τ}_{th} \geq ln ( 1 - {o}_{o u t} )$$

Herein, P[τᵥ_{_{i,}}ᵣ_{_{k,}}ᵥ_{ⱼ}≤τₜₕ] is assumed to follow a symmetric probability distribution in the given possible range.

In this case, the probability of satisfying the inequality of [Mathematical Formula 6] may be expressed as [Mathematical Formula 7].

$$[ Mathematical Formula 7 ]$$

$${P}^{sat} \leq Φ ( \frac{\vert \hat{R} ( {f}_{{v}_{i} , {v}_{j}^{t}} ) \vert - 1}{\sqrt{\vert R ( {f}_{{v}_{i} , {v}_{j}^{t}} ) \vert}} )$$

Herein,

$$Φ = \frac{1}{\sqrt{2 π}} {\int }_{- ∞}^{α} exp - \frac{β}{2} d β , and 1 \leq \vert \hat{R} ( {f}_{{v}_{i} , {v}_{j}^{t}} ) \vert \leq \vert R ( {f}_{{v}_{i} , {v}_{j}^{t}} ) \vert .$$

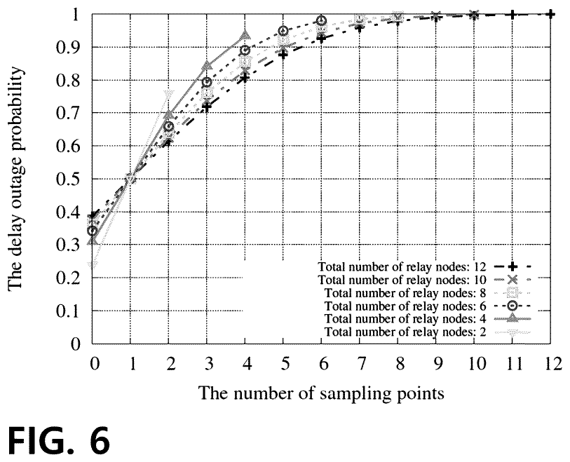

FIG. 6 shows the upper limit of the delay outage probability as a function of the relay node 10 performing sampling. Shapes are displayed differently depending on the total number of relay nodes 110 in the traffic sampling system 100.

Referring to FIG. 6, it can be seen that the upper limit of the delay outage probability increases as the number of relay nodes 110 performing sampling increases.

In [Mathematical Formula 4] above, the detection success probability for a certain flow is calculated. The overall detection success probability for all flows at time t is normalized by adding the success probabilities for all flows. Herein, the normalizing constant is

$$\frac{1}{\vert {F}_{V}^{t} \vert} .$$

The overall detection success probability may be expressed as [Mathematical Formula 8].

$$[ Mathematical Formula 8 ]$$

$$\begin{matrix}{\overline{P}}^{succ} = ( \hat{R} ( {F}_{V}^{𝔱} ) , {F}_{V}^{t} , {Δ}_{{F}_{V}^{t}} ) \\ = \frac{1}{\vert {F}_{V}^{t} \vert} {\sum }_{{f}_{{v}_{i} , {v}_{j}^{t}} ∈ {F}_{V}^{t}} {P}^{succ} ( \hat{R} ( {f}_{{v}_{i} , {v}_{j}^{t}} ) , {f}_{{v}_{i} , {v}_{j}^{t}} , {Δ}_{{f}_{{v}_{i} , {v}_{j}^{t}}} ) \\ = \frac{1}{\vert {F}_{V}^{t} \vert} {\sum }_{{f}_{{v}_{i} , {v}_{j}^{t}} ∈ {F}_{V}^{t}} ( 1 - {\prod }_{{r}_{k} ∈ \hat{R} ( {f}_{{v}_{i} , {v}_{j}^{t}} )} {P}^{fail} ( {r}_{k} , {f}_{{v}_{i} , {v}_{j}^{t}} , {Δ}_{{f}_{{v}_{i} , {v}_{j}^{t}}} ) )\end{matrix}$$

Similarly, considering [Mathematical Formula 7], the upper limit of the outage probability of delay constraint for all flows at time t may be expressed as [Mathematical Formula 9].

$$[ Mathematical Formula 9 ]$$

$$\begin{matrix}{\overline{P}}^{out , upper} = \hat{( R} ( {F}_{V}^{𝔱} ) , {F}_{V}^{t} , {Δ}_{{F}_{V}^{t}} ) \\ = \frac{1}{\vert {F}_{V}^{t} \vert} {\sum }_{{f}_{{v}_{i} , {v}_{j}^{t}} ∈ {F}_{V}^{t}} {P}^{out , upper} ( \hat{R} ( {f}_{{v}_{i} , {v}_{j}^{t}} ) , {f}_{{v}_{i} , {v}_{j}^{t}} , {Δ}_{{f}_{{v}_{i} , {v}_{j}^{t}}} ) \\ = \frac{1}{\vert {F}_{V}^{t} \vert} {\sum }_{{f}_{{v}_{i} , {v}_{j}^{t}} ∈ {F}_{V}^{t}} Φ ( \frac{\hat{\vert R} ( {f}_{{v}_{i} , {v}_{j}^{t}} ) \vert - 1}{\sqrt{\vert ( {f}_{{v}_{i} , {v}_{j}^{t}} ) \vert}} )\end{matrix}$$

Considering [Mathematical Formula 8] and [Mathematical Formula 9], depending on the total sampling rates Δ_{F}_{_{V}}_{^{t}} or the number of relay nodes 110 participating in sampling |\hat{R}(fᵥ_{_{i,}}ᵥ_{ⱼ}^{t})|, the detection success probability may increase or the outage probability of delay constraint may increase. Since the object of the network malicious packet detection service is to increase the detection success probability and lower the outage probability of delay constraint, they can be said to be in a trade-off relationship.

The present invention introduces the trade-off parameter A and models the service such that the total sampling rate is determined as in [Mathematical Formula 10] below.

$$[ Mathematical Formula 10 ]$$

$${max}_{{Δ}_{{F}_{V}^{t}}} λ {\overline{P}}^{succ} ( \hat{R} ( {F}_{V}^{t} ) , {F}_{v}^{t} , {Δ}_{{F}_{V}^{t}} )$$

$$- ( 1 - λ ) {\overline{P}}^{out , upper} ( \hat{R} ( {F}_{V}^{t} ) , {F}_{v}^{t} , {Δ}_{{F}_{V}^{t}} )$$

$$s . t . {\sum }_{{f}_{{v}_{i} , {v}_{j}^{t}} ∈ {F}_{V}^{t}} {\sum }_{{r}_{k} ∈ \hat{R} ( {f}_{{v}_{i} , {v}_{j}^{t}} )} D ( {f}_{{v}_{i} , {v}_{j}^{t}} ) {δ}_{{f}_{{v}_{i} , {v}_{j}^{t}} , {r}_{k}} \leq {I}_{nIDS}$$

In [Mathematical Formula 10], the limiting condition may be expressed as a condition that “the total amount of sampling data will not exceed the processing capacity of the packet inspection server 200.” In addition, 0≤λ≤1.

Referring to [Mathematical Formula 10], when the λ value approaches 0, it can be said that the service places more importance on delay constraint situations than on the success of detecting malicious packets. In other words, it can be said that network speed or stability is given priority.

When the λ value approaches 1, the service may be said to place more importance on the success of detecting malicious packets than on delay constraints. When λ is 1, it can be said that the probability of malicious packet detection is maximized within the upper limit range of the outage probability of delay constraint and the performance limit range of the packet inspection server 200.

Meanwhile, Δ_{F}_{_{V}}_{^{t}} is a set of total sampling rates that vary depending on how the sampling rate is determined at each relay node 110.

Finding the maximum value in [Mathematical Formula 10] means finding the λP̅^{succ}−(1−λ)P̅^{out,upper} value for all possible Δ_{F}_{_{V}}_{^{t}} and then finding the maximum value among all values. Since calculating the number of all cases requires infinite steps, determining the appropriate number of calculations and finding the maximum value among these values is one of the ways to actually apply [Mathematical Formula 10]. The appropriate number of calculations refers to the number of repetitions in step S260 in the exemplary embodiment of the present invention.

In step S210, the traffic sampling system 100 determines the trade-off parameter λ and the number of repetitions Nₘₐₓ. Herein, the number of repetitions may be the number of times that steps S240 and S250 are repeated (one trial includes repetition by step S250).

In step S220, the traffic sampling system 100 determines the number of relay nodes 110 |R(fᵥ_{_{i,}}ᵥ_{ⱼ}^{t})| required for fᵥ_{_{i,}}ᵥ_{ⱼ}^{t}. The number of relay nodes 110 is calculated for all flows. In other words, it is obtained for all i, j.

In step S230, the traffic sampling system 100 sorts flows according to the required number of relay nodes 110. Herein, flows may be numbered in rows, and each relay node 110 may be numbered in columns for each flow.

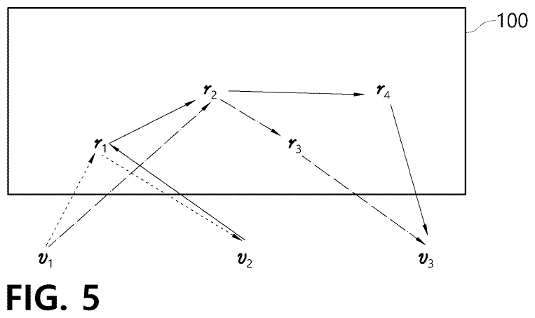

FIG. 5 is a visual representation of the entire flow at time t according to an exemplary embodiment of the present invention. Each flow is indicated with a different shape. This example is prepared to help understand the steps of the present invention and does not take into account the actual routing efficiency between each relay node 110.

Referring to FIG. 5, in the case of fᵥ_{_{1,}}ᵥ_{₂}^{t} (indicated in dashed line), only the relay node 110 r₁ is required. In this case, |R(fᵥ_{_{1,}}ᵥ_{₂}^{t})|=1.

In case of fᵥ_{_{1,}}ᵥ_{₃}^{t} (marked in dash dotted line), relay nodes 110 r₂ and r₃ are required. In this case, |R(fᵥ_{_{1,}}ᵥ_{₂}^{t})|=2.

In the case of fᵥ_{_{2,}}ᵥ_{₃}^{t} (shown in solid line), relay nodes 110 r₁, r₂ and r₄ are required. In this case, |R(fᵥ_{_{1,}}ᵥ_{₂}^{t})|=3.

For the convenience of explanation, fᵥ_{_{1,}}ᵥ_{₂}^{t}, fᵥ_{_{1,}}ᵥ_{₃}^{t} and fᵥ_{_{2,}}ᵥ_{₃}^{t} are expressed as f₁, f₂ and f₃, respectively.

The order of the relay nodes 110 for each flow may be arranged in order of the flow. This is expressed in [Table 1].

TABLE 1

| | First Relay | Second Relay | Third Relay |
|---|---|---|---|
| | Node (110) | Node (110) | Node (110) |
| f₁ | r₁ | — | — |
| f₂ | r₂ | r₃ | — |
| f₃ | r₁ | r₂ | r₄ |

Table 1 sorts the flows as rows in ascending order of the number of relay nodes 110 required for each flow, and relay nodes 110 for each flow as columns in order of flow.

In step S240, the traffic sampling system 100 generates a sampling rate of all flows for each relay node 110.

Specifically, the traffic sampling system 100 generates a sampling rate

of the first relay node 110 for each flow. The first relay node 110 refers to the relay node 110 that each flow passes through first. The sampling rate may be generated as a random value within a preset range. In this step, in [Table 1] above, the first relay nodes 110 for flows f₁, f_{Z} and f₃ are r₁, r₂ and r₁, respectively. First of all, the sampling ratio
of r₁ for f₁ is generated. Next, the sampling ratio
of r₂ for f₂ is generated. However, in the following order, the sampling ratio
of r₁ for f₃ is not generated again (a method of updating is also possible depending on the exemplary embodiment). This is because all flows passing through each relay node 110 at time t are determined, and thus, there is no need to repeatedly generate the sampling rate for r₁. In this example, since the sampling rate can be viewed as a function only of the relay node 110, the sampling rates for each relay node 110 r₁, r₂, r₃ and r₄ will be briefly written as δ₁, δ₂, δ₃ and δ₄, respectively.

In step S245, it is determined whether the constraint condition of [Mathematical Formula 10] is satisfied, and if so, the determined sampling rate is stored. Specifically, for δ₁ and δ₂ determined in the above example, it is determined whether (D(f₁)+D(f₃))δ₁+(D(f₂)+D(f₃))δ₂≤I_{nIDS} is satisfied.

If the constraint condition is satisfied, δ₁ and δ₂ are stored, and if not, δ₁ and δ₂ are not stored, and the process proceeds to step S250. However, it is desirable that cases where the above constraint condition is not satisfied in the first step do not occur. Through this step, at least one relay node 110 that performs sampling may be determined at time t for all flows.

In step S250, the traffic sampling system 100 determines whether steps S240 and S245 have been performed for all relay nodes 110. If these steps are performed, the process proceeds to step S260. Otherwise, the process returns to step S240 and performs steps S240 and S245 for the next relay node 110.

For example, the descriptions of steps S240 and S245 for the second relay node 110 are as follows. There is no second relay node 110 for f₁. The second relay node 110 for f₂ is r₃. The second relay node 110 for f₃ is r₂. The sampling rate for r₃ may be determined as δ₃. The second relay node 110 for f₃ is not determined again because the sampling rate of r₂ has already been determined.

In the second step S245, the constraint condition is (D(f₁)+D(f₃))δ₁+(D(f₂)+D(f₃))δ₂+D(f₂)δ₃≤I_{nIDS}.

If the constraint condition is satisfied, δ₃ is additionally stored, and if it is not satisfied, δ₃ is not stored.

For example, the descriptions of steps S240 and S245 for the third relay node 110 are as follows. There is no third relay node 110 for f₁. There is also no third relay node 110 for f₂. The third relay node 110 for f₃ is r₄. The sampling rate for r₄ may be determined as δ₄.

In the third step S245, the constraint condition is (D(f₁)+D(f₃))δ₁+(D(f₂)+D(f₃))δ₂+D(f₂)δ₃+D(f₃)δ₄≤I_{nIDS}.

If the constraint condition is satisfied, δ₄ is additionally stored, and if it is not satisfied, δ₄ is not stored.

If this step is performed for all relay nodes 110, Δ_{F}_{_{V}}^{t} is determined.

In step S260, the traffic sampling system 100 determines whether the number of repetitions has reached a set value. Herein, the set value is Nₘₐₓ. If the number of repetitions is not equal to the set value, the process returns to step S240 and generates a new set. If the number of repetitions is equal to the set value, the process proceeds to step S270.

Δ_{F}_{_{V}}^{t} may be determined as a different set by the number of repetitions Nₘₐₓ. In order to distinguish the same, subscripts or superscripts will be used.

If the number of repetitions is (Δ_{F}_{_{V}}_{^{t}})₁ generated for the first time Δ_{F}_{_{V}}_{^{t}}, it may be expressed as (Δ_{F}_{_{V}}_{^{t}})₁={δ₁⁽¹⁾, δ₂⁽¹⁾, δ₄⁽¹⁾}. Herein, in the first case, it was assumed that δ₃ was not stored because it did not satisfy the constraint condition (hereinafter, the same applies to a case where there is no delta value for a specific relay node in the set).

If Δ_{F}_{_{V}}_{^{t}} generated at the second repetition count is (Δ_{F}_{_{V}}_{^{t}})₂, it may be expressed as (Δ_{F}_{_{V}}_{^{t}})₂={δ₁⁽²⁾, δ₂⁽²⁾, δ₃⁽²⁾, δ₄⁽²⁾}.

If Δ_{F}_{_{V}}_{^{t}} generated at the third repetition count is (Δ_{F}_{_{V}}_{^{t}})₃, it may be expressed as (Δ_{F}_{_{V}}_{^{t}})₃={δ₁⁽³⁾, δ₃⁽³⁾, δ₄⁽³⁾}.

If Δ_{F}_{_{V}}_{^{t}} generated at the Nₘₐₓ number of repetitions is (Δ_{F}_{_{V}}_{^{t}})_{N}_{ₘₐₓ}, it may be expressed as (Δ_{F}_{_{V}}_{^{t}})_{N}_{ₘₐₓ}={δ₁^{(N}^{ₘₐₓ}⁾, δ₃^{(N}^{ₘₐₓ}⁾, δ₄^{(N}^{ₘₐₓ}⁾}.

By step S260, when steps S240 to S250 are repeated Nₘₐₓ times (certainly, steps S240 to S245 are repeated as many times as the number of relay nodes 110 each time, but for the convenience of explanation, herein, they are described as one repetition), the Nₘₐₓ number of Δ_{F}_{_{V}}_{^{t}} may be obtained. Depending on the exemplary embodiment, it may be possible to update only Δ_{F}_{_{V}}_{^{t}} that maximizes the result of substitution in [Mathematical Formula 10] without storing all Δ_{F}_{_{V}}_{^{t}}. For example, if the value of newly generated Δ_{F}_{_{V}}_{^{t}} substituted into [Mathematical Formula 10] is smaller than the value of previously generated Δ_{F}_{_{V}}_{^{t}} substituted into [Mathematical Formula 10], the newly generated Δ_{F}_{_{V}}_{^{t}} is not stored, and if it is larger, it may be saved or updated with new Δ_{F}_{_{V}}_{^{t}}.

In step S270, the traffic sampling system 100 determines a value that satisfies the sampling selection condition among the stored sampling sets. Herein, the sampling selection condition may satisfy [Mathematical Formula 10].

In the above example, [Mathematical Formula 10] means a set (Δ_{F}_{_{V}}_{^{t}})_{N} that maximizes λP̅^{succ}−(1−λ)P̅^{out,upper} for all N=1, 2, 3, . . . , Nₘₐₓ. In other words,

$${max}_{( {Δ}_{{F}_{V}^{t}} ) N} λ {\overline{P}}^{succ} - ( 1 - λ ) {\overline{P}}^{out , upper}$$

is found.

For example, N=3.

In this case, (Δ_{F}_{_{V}}_{^{t}})₃={δ₁⁽³⁾, δ₃⁽³⁾, δ₄⁽³⁾} is determined as a sampling set to be obtained.

In the above exemplary embodiment, in step S300, the traffic sampling system 100 may respectively perform packet sampling by r₁, r₃ and r₄ by (Δ_{F}_{_{V}}_{^{t}})₃=(δ₁⁽³⁾, δ₃⁽³⁾, δ₄⁽³⁾) at time t. The sampled packets are mirrored to the packet inspection server 200.

The packet inspection server 200 inspects received packets for malicious packets, and information regarding the malicious packets may be fed back to the traffic sampling system 100.

The packet inspection server 200 and/or the traffic sampling system 100 may transmit information regarding whether a malicious packet has been detected to the vehicle 500 or transmit the same to at least one of the first user terminal 300 and the second user terminal 400 for notification.

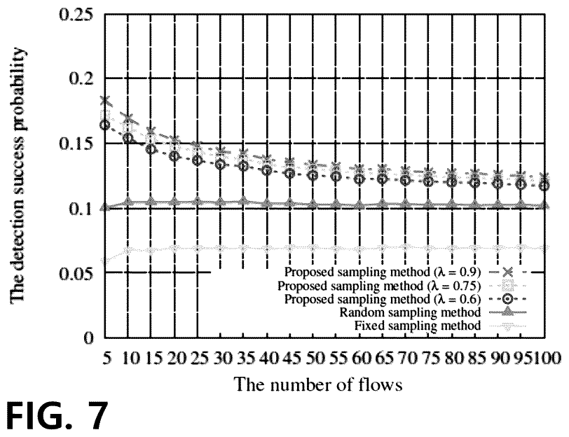

FIG. 7 to 9 are graphs showing the detection success probability, the outage probability of delay constraint and detection efficiency when the number of relay nodes 110 is 6, respectively. Herein, the processing capacity of the packet inspection server 200 was set to 10% of all traffic scenarios.

In the graphs, three exemplary embodiments of the method of the present invention are displayed for different λ values (0.9, 0.75, 0.6), and each one of a random sampling rate applied for each relay node 110 and a fixed sampling rate applied for each relay node 110 is shown.

In FIG. 7, it can be seen that the detection success probability also increased as the λ value increased. Additionally, in terms of the detection success probability, it can be seen that the sampling decision according to the method of the present invention had a higher detection success probability in all sections compared to the random sampling and fixed sampling methods.

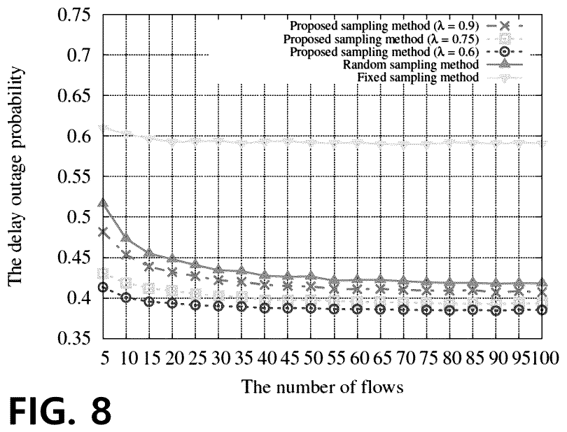

In FIG. 8, it can be seen that the outage probability of delay constraint decreased as the λ value decreased. Additionally, in terms of the outage probability of delay constraint, it can be seen that the sampling decision according to the method of the present invention had a lower outage probability of delay constraint in all sections compared to the random sampling and fixed sampling methods.

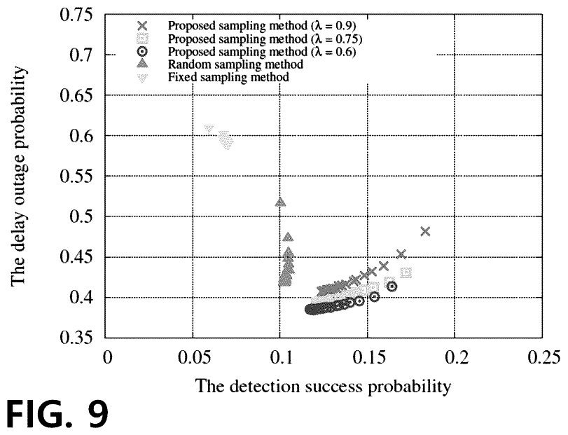

In FIG. 9, it can be seen that the efficiency of the sampling decision by the method of the present invention in terms of the detection success probability and the outage probability of delay constraint was improved compared to the random sampling and fixed sampling methods. Herein, improved efficiency may mean a higher detection success probability and a lower outage probability of delay constraint compared to other methods. However, the outage probability of delay constraint was not low in all cases.

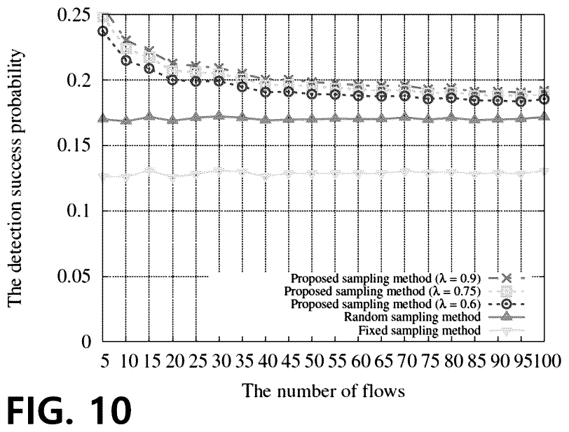

FIGS. 10 to 12 are graphs showing the detection success probability, the outage probability of delay constraint and detection efficiency, respectively, when the number of relay nodes 110 is 12. Conditions except for the number of relay nodes 110 are the same as those in FIGS. 7 to 9.

In FIGS. 10 to 12, it can be seen that the overall detection success probability increased due to an increase in routing paths.

In FIG. 10, it can be seen that the detection success probability also increased as the λ value increases. Additionally, in terms of the detection success probability, it can be seen that the sampling decision according to the method of the present invention had a higher detection success probability in all sections compared to the random sampling and fixed sampling methods.

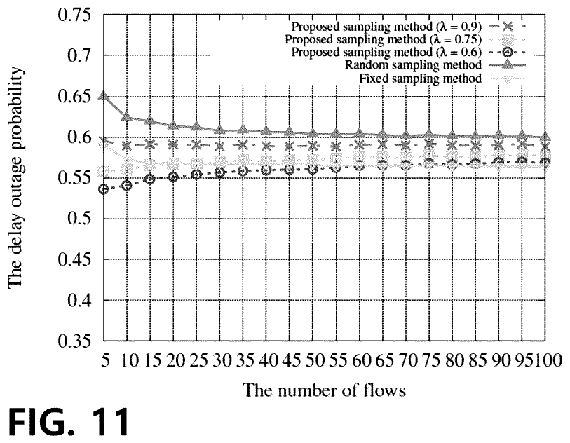

In FIG. 11, it can be seen that the outage probability of delay constraint decreased as the λ value decreased. Additionally, in terms of the outage probability of delay constraint, it can be seen that the sampling decision according to the method of the present invention had a lower outage probability of delay constraint in all sections compared to the random sampling and fixed sampling methods. It can be seen that according to the fixed sampling method, the outage probability of delay constraint rarely changed.

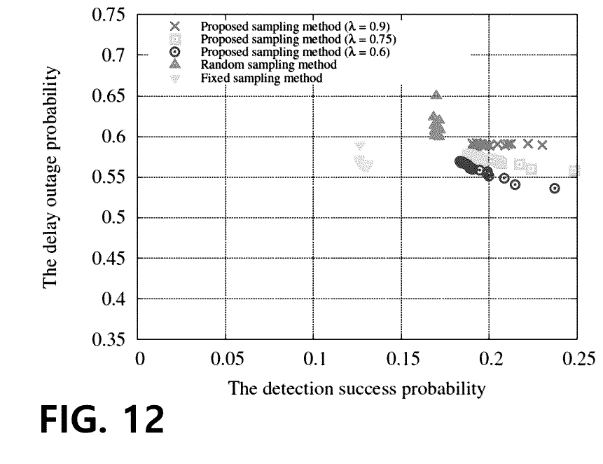

In FIG. 12, it can be seen that the efficiency of the sampling decision by the method of the present invention in terms of the detection success probability and the outage probability of delay constraint was improved compared to the random sampling and fixed sampling methods. Herein, improved efficiency may mean a higher detection success probability and a lower outage probability of delay constraint compared to other methods. However, the outage probability of delay constraint was not low in all cases.

The terms used in the present application are merely used to describe particular exemplary embodiments, and are not intended to limit the present invention. In the present application, it is to be understood that the terms such as “include” or “have” are intended to indicate the existence of the features, numbers, steps, actions, components, parts or combinations thereof disclosed in the specification, and are not intended to preclude the possibility that one or more other features, numbers, steps, actions, components, parts or combinations thereof may exist or may be added.

### EXPLANATION OF REFERENCE NUMERALS

100: Traffic sampling system
110: Relay node
200: Packet inspection server
300: First user terminal
400: Second user terminal
500: Vehicle
510: Vehicular packet monitoring unit
600: Base station

1. A method for traffic sampling in vehicular networks, comprising the steps of:
receiving inter-vehicle flow information; and
determining a sampling amount to extract some of data included in the flow information,
wherein the step of determining a sampling amount comprises the steps of:
setting a trade-off parameter which sets a weight between a detection success probability and an outage probability of delay constraint, by considering the trade-off relationship between the detection success probability of malicious packets included in the data and the outage probability of delay constraint on networks involved in inter-vehicle flows;
generating a sampling set by generating sampling rates at least two times for each relay node involved in the flow; and
determining a sampling set by selecting any one of sets of the sampling rates for each relay node generated two times or more.

2. The method of claim 1, wherein the step of determining a sampling set selects a set that maximizes a value calculated by Mathematical Formula below among the sets of sampling rates:
$$[ Mathematical Formula 11 ]$$
$$λ {\overline{P}}^{succ} - ( 1 - λ ) {\overline{P}}^{out , upper}$$
(wherein λ represents the trade-off parameter, P̅^{succ} represents the detection success probability for the sampling rate set, and P̅^{out,upper} represents the upper limit of the outage probability of delay constraint for the sampling rate set).

3. The method of claim 1, further comprising the step of:
sampling traffic according to the determined sampling rate and transmitting to a packet inspection server,
wherein the step of generating a sampling set generates the sampling set on a condition that the total amount of data transmitted to the packet inspection server according to the traffic amount of each relay node and the determined sampling rate is lower than or equal to the processing capacity of the packet inspection server.

4. The method of claim 1, wherein the sampling rate for each relay node involved in the flow is generated as a random value within a set range.

5. The method of claim 2, wherein the step of determining a sampling amount further comprises the steps of:
calculating a required number of relay nodes for all flows;
sorting flows in ascending order corresponding to the number of relay nodes, and sorting the relay nodes in flow order of each flow;
generating sampling rates for all flows in the sorted relay node order and in the sorted flow order;
storing the generated sampling rates as a sampling rate set; and
generating two or more sampling rate sets by repeating the steps of generating sampling rates and storing the sampling rate set as many times as a preset number of repetitions.

6. A system for traffic sampling in vehicular networks, comprising:
at least one relay node for routing packets transmitted in vehicle-to-vehicle communication; and
a processor for controlling individual routing of the relay node,
wherein the processor receives inter-vehicle flow information and determines a sampling amount to extract some of data included in the flow information, and
wherein determining a sampling amount is performed:
by setting a trade-off parameter which sets a weight between a detection success probability and an outage probability of delay constraint, by considering the trade-off relationship between the detection success probability of malicious packets included in the data and the outage probability of delay constraint on networks involved in inter-vehicle flows,
by generating sampling rates at least two times for each relay node involved in the flow, and
by selecting any one of sets of the sampling rates for each relay node generated two times or more.
